(19) United States
(12) Patent Application Publication
(10) Pub. No.: US 2009/0041509 A1
(43) Pub. Date: Feb. 12, 2009

(54) Image forming apparatus having replaceable developer cartridges

(75) Inventor: Susumu Sakuma, Kasugai-shi (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: Brother Kogyo Kabushiki Kaisha, Nagoya-shi (JP)

(21) Appl. No.: 12/222,494

(22) Filed: Aug. 11, 2008

(30) Foreign Application Priority Data
Aug. 10, 2007 (JP) 2007-210462

(51) Int. Cl. G03G 15/08

(52) U.S. Cl. 399/262

(57) ABSTRACT

An arrangement for providing developer to process cartridges is described. Developer agent storing members may be insertable into a body containing the process cartridges through a front of the body. The developer agent storing members may be provided on two sides to reduce the stacked height of the developer agent storing members in the body.

### CROSS REFERENCE TO RELATED APPLICATION

This application claims priority from Japanese Patent Application No. 2007-210462, filed on Aug. 10, 2007, the entire subject matter of which is incorporated herein by reference.

### TECHNICAL FIELD

Aspects of the invention relate to tandem-type image forming apparatuses.

### BACKGROUND

A known tandem-type image forming apparatus includes a plurality of process cartridges spaced in a line, and is configured to print a color image at once.

The image forming apparatus is configured such that toner cartridges can be removed and replaced from the top of the apparatus. Thus, the image forming apparatus requires a space for toner cartridge replacement above, so that its installation site may be limited. When an image reading unit is provided on the top of the image forming apparatus, the toner cartridges cannot be removed from above, and the apparatus should undergo some design changes relating to toner cartridge replacement.

### SUMMARY

Aspects of the invention provide an image forming apparatus configured to facilitate toner cartridge replacement without a need to involve design changes in the limitation of the installation site or the availability of an image reading unit.

### BRIEF DESCRIPTION OF THE DRAWINGS

Illustrative aspects of the invention will be described in detail with reference to the following figures in which like elements are labeled with like numbers and in which:

FIG. 1 is a side sectional view of an internal structure of a color laser printer as an illustrative example of an image forming apparatus according to an illustrative embodiment of the invention;

FIG. 2 is a perspective view of an appearance of the color laser printer of FIG. I in which a frame accommodating process cartridges is pulled out;

FIG. 3 is a perspective view of the color laser printer where a toner cartridge is replaced; and

FIG. 4 is a front view of a color multifunction apparatus as another example of the image forming apparatus.

### DETAILED DESCRIPTION

An illustrative embodiment of the invention will be described in detail with reference to the accompanying drawings. An image forming apparatus according to aspects of the invention applies to a color laser printer 1. It will be appreciated that aspects of the invention apply to other types of image forming apparatuses as well.

It is noted that various connections are set forth between elements in the following description. It is noted that these connections in general and, unless specified otherwise, may be direct or indirect and that this specification is not intended to be limiting in this respect.

For purposes herein, aspects of the invention are shown in relation to an image carrier and developer carrier. In various aspects, the image carrier may include a photosensitive drum, photosensitive belt, or the combination of one of a photosensitive drum or belt and an intermediate transfer drum or belt. Further, the developer carrier may include a developer roller or other systems for conveying developer to the image carrier.

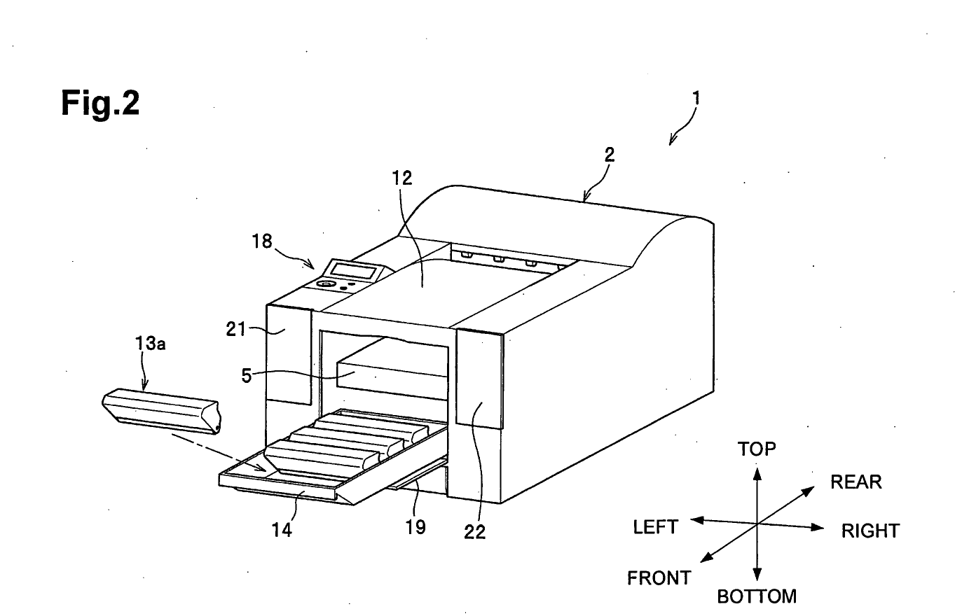

For ease of discussion, in the following description, directions are defined as viewed from a user who operates the color laser printer 1. The top or upper side, the bottom or lower side, the left or left side, the right or right side, the front or front side, and the rear or rear side of the color laser printer 1 are identified as indicated by the arrows in FIG. 2. With regard to various individual objects of the color laser printer 1, sides of the individual objects are similarly identified based on the arranged/attached position of the object on/in the color laser printer 1.

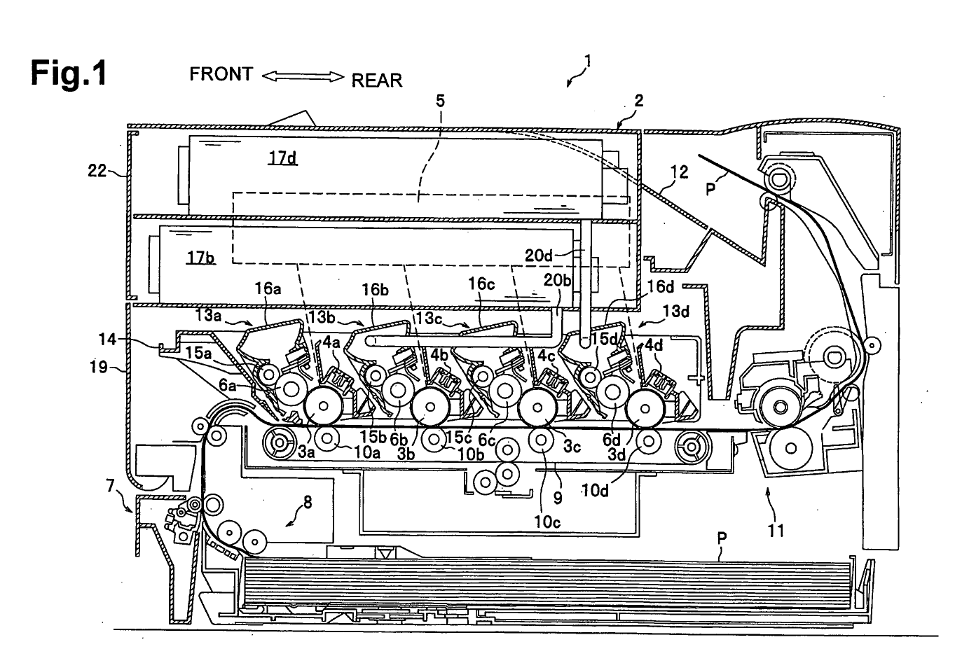

As shown in FIG. 1, the color laser printer 1 may include a plurality of, e.g., four, photosensitive drums 3a-3d arranged in parallel to each other in a front-rear direction in a body case 2. Surfaces of the photosensitive drums 3a-3d are regularly charged by corresponding scorotron chargers 4a-4d and irradiated by laser beams emitted from an exposure unit 5, and electrostatic latent images are formed on the surfaces based on image data. The electrostatic latent images formed on the surfaces of the photosensitive drums 3a-3d are developed into toner images with corresponding colors of toner (developer) carried on developing rollers 6a-6d.

A stack of sheets P is stored in a sheet supply cassette 7 disposed in a bottom portion of the body case 2. A topmost sheet P is separated from the stack of sheets P by rollers in a sheet supply portion 8 disposed in a front portion of the body case 2 and conveyed upward to a conveyor belt 9 disposed above and rearward of the sheet supply portion 8. The conveyor belt 9 is disposed facing the photosensitive drums 3a-3d. Transfer rollers 10a-10d are disposed within the conveyor belt 9 to face the corresponding photosensitive drums 3a-3d via the conveyor belt 9. By the action of the transfer rollers 10a-10d that are biased, toner images in each color on the photosensitive drums 3a-3d are successively overlapped each other and transferred onto the sheet P conveyed to the conveyor belt 9. The sheet P having four-color toner images thereon is conveyed to a fixing unit 11. The toner images transferred onto the sheet P are thermally fixed by the fixing unit 11, and the sheet P is ejected upward to an output tray 12 by changing the sheet feeding direction from rear to front by rollers.

A plurality of, e.g., four, process cartridges 13a-13d are disposed between the sheet supply cassette 7 and the exposure unit 5 in the body case 2. The process cartridges 13a-13d are arranged in tandem in the front-rear direction. The process cartridges 13a-13d are held in a frame 14 in a detachable manner. The frame 14 is configured to be attached to and removed from the body case 2.

The process cartridges 13a-13d include the photosensitive drums 3a-3d, the scorotron chargers 4a-4d, the developing rollers 6a-6d, supply rollers 15a-15d, and toner hoppers 16a-16d. The process cartridges 13a-13d are identical in structure except that they have different colors of toner supplied from toner cartridges 17a-17d to the toner hoppers 16a 16d. Toner is supplied from the toner cartridges 17a-17d via the toner hoppers 16a-16d and the supply rollers 15a-15d to the developing rollers 6a-6d.

As shown in FIG. 2, an operation unit 18 is disposed at a left front side on an upper surface of the body case 2, so that a user can manipulate the operation unit 18 in front of the color laser printer 1. A front surface of the body case 2 contains a front cover 19. The front cover 19 is pivotally mounted at its lower end to the body case 2. The frame 14 holding the process cartridges 13a-13d can be pulled toward the front through an opening formed when the front cover 19 is opened. With the frame 14 pulled toward the front, the process cartridges 13a-13d can be replaced.

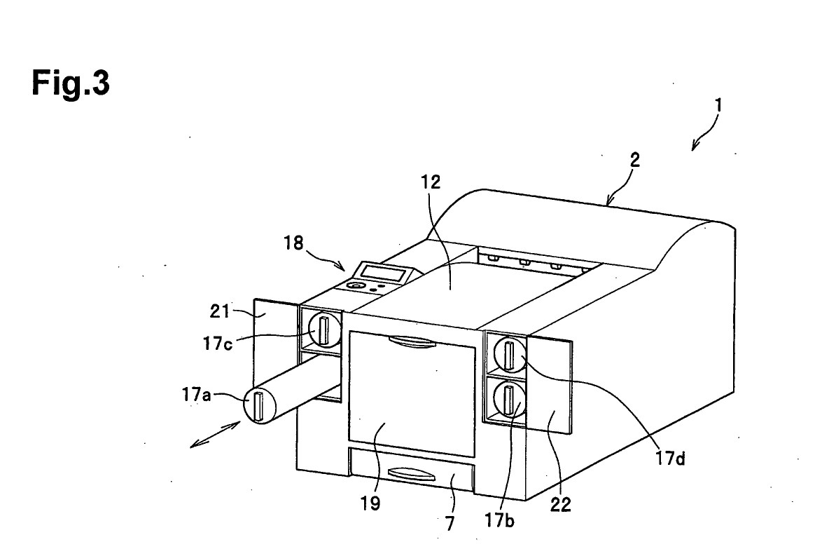

As shown in FIGS. 1 and 3, the toner cartridges 17a-17d are disposed two by two on both sides of the exposure unit 5 above the process cartridges 13a-13d in the body case 2. The toner cartridges 17a, 17c are vertically arranged on the left side and the toner cartridges 17b, 17d are vertically arranged on the right side. The two vertically arranged toner cartridges 17b, 17d or 17a, 17c are shifted in a direction where the process cartridges 13a-13d are arranged in tandem or in the front-rear direction, as shown in FIG. 1. In other words, the rear end of the upper toner cartridge 17d or 17c is positioned slightly more rearward than the rear end of the lower cartridge 17b or 17a. Toner supply tubes 20a-20d (20a, 20c not shown) are connected on rear sides of the corresponding toner cartridges 17a-17d. Each toner supply tube 20a-20d extends vertically downward from the underside of the corresponding toner cartridge 17a-17d. When the toner cartridge 17a-17d is removed from the body case 2, it is disconnected from the corresponding toner supply tube 20a-20d.

The toner cartridges 17a-17d are cylindrical in shape, and disposed to extend in the direction where the process cartridges 13a-13d are arranged in tandem, i.e., in the front-rear direction of the body case 2. As shown in FIG. 3, toner cartridge covers 21, 22, are disposed on the front surface of the body case 2. The toner cartridges 17a-17d are configured to be pulled out from openings formed when the toner cartridge covers 21, 22 are opened. In this manner, the toner cartridges 17a-17d can be replaced from the front side where the user manipulates the operation unit 18.

Toner contained in each toner cartridge 17a-17d is supplied via the toner supply tube 20a-20d to the toner hopper 16a-16d of the process cartridge 13a-13d as shown in FIG. 1. The toner cartridges 17a-17d are identical in structure except that they each contain different colors of toner. Preferably, each toner cartridge 17a-17d has a known conveying device (not shown), such as an auger, for agitating and conveying toner to the rear of the toner cartridge 17a-17d (rearward of the body case 2).

Advantages of aspects of the color laser printer 1 described above include the following.

As the toner cartridges 17a-17d can be pulled toward the front, they can be easily replaced, and the operability of the color laser printer 1 can be improved.

The toner cartridges 17a-17d are disposed above the process cartridges 13a-13d. Thus, through the use of gravitation, toner in the toner cartridges 17a-17d can be supplied via the toner supply tubes 20a-20d to the toner hoppers 16a-16d of the process cartridges 13a-13d. Toner can be more efficiently supplied by provision of a conveying device such as an auger (not shown) inside each toner supply tube 20a-20d.

The exposure unit 5 can be made in a width the same as or narrower than the image formation area width, but the developing rollers 6a-6d and the photosensitive drums 3a-3d should be made wider than the image formation area width. As a result, a space is formed on each side of the exposure unit 5. In this embodiment, four toner cartridges 17a-17d are disposed two on each side of the exposure unit 5, so that a space inside the body case 2 can be efficiently used.

In the body case 2, a space under which each toner cartridge 17a-17d is disposed can accommodate a driving unit (now shown) for applying power to rollers including photosensitive drums 3a-3d and an electrode as a heating device of the fixing unit 11. Thus, the space inside the body case 2 can be efficiently used and the body case 2 can be reduced in size.

As the toner cartridges 17a-17d are disposed on both sides of the exposure unit 5, there is no need to provide a toner chamber having a certain capacity in each process cartridge 13a-13d. Thus, the process cartridges 13a-13d can be reduced in size, especially in height. As the process cartridges 13a-13d can be reduced in height, the body case 2 also can be reduced in height, and the color laser printer 1 can be provided with a low-profile design.

The toner cartridges 17a-17d are disposed so that a direction of their length extends in the direction where the process cartridges 13a-13d are arranged in tandem, i.e., in the front-rear direction of the body case 2. Thus, the size of each toner cartridge 17a-17d can be secured greatly in its longitudinal direction. In addition, the volume of each toner cartridge 17a-17d also can be increased.

The two vertically arranged toner cartridges 17b, 17d (or 17a, 17c) are disposed out of alignment with each other in the direction where the process cartridges 13a-13d are arranged in tandem, so that the toner supply tubes 20a-20d connected on lower parts on the rear of the corresponding toner cartridges 17a-17d can be extended vertically downward. In other words, as the upper and lower toner cartridges 17b, 17d (or 17a, 17c) are disposed out of alignment with each other in the front-rear direction, paths to supply toner from the toner cartridges 17a-17d to the toner hoppers 16a-16d (or an arrangement of the toner supply tubes 20a-20d) can be simplified.

As the frame 14 that holds the process cartridges 13a-13d detachably is configured to be capable of moving in the same direction as the toner cartridges 17a-17d are attached to or removed from the body case 2, the toner cartridges 17a-17d and the process cartridges 13a-13d can be easily replaced. Thus, the operability of the color laser printer 1 can be improved. In addition, the process cartridges 13a-13d and the toner cartridges 17a-17d can be replaced from the front side where the operation unit 18 is manipulated, there is no need to provide a space for replacement above, and thus there is no restraint on the installation site.

In the above embodiment, each process cartridge 13a-13d integrally includes the photosensitive drum 3a-3d and the developing roller 6a-6d. However, the process cartridge 13a-13d may be a separable combination of a cartridge including the photosensitive drum 3a-3d and a cartridge including the developing roller 6a-6d.

In the above embodiment, the four toner cartridges 17a-17d are disposed two on each side of the exposure unit 17. The number of toner cartridges is not limited to four. Three or more toner cartridges may be disposed on each side of the exposure unit 5. Alternatively, the number of toner cartridge disposed on each side may be different. For example, one toner cartridge may be disposed on one side of the exposure unit 5 and three toner cartridges may be disposed on the other side of the exposure unit 5.

In the above embodiment, the toner cartridges 17a-17d are identical in size. However, the toner cartridges 17a-17d may be different in size. For example, a toner cartridge containing black toner, which is relatively quickly used up, may be increased in size.

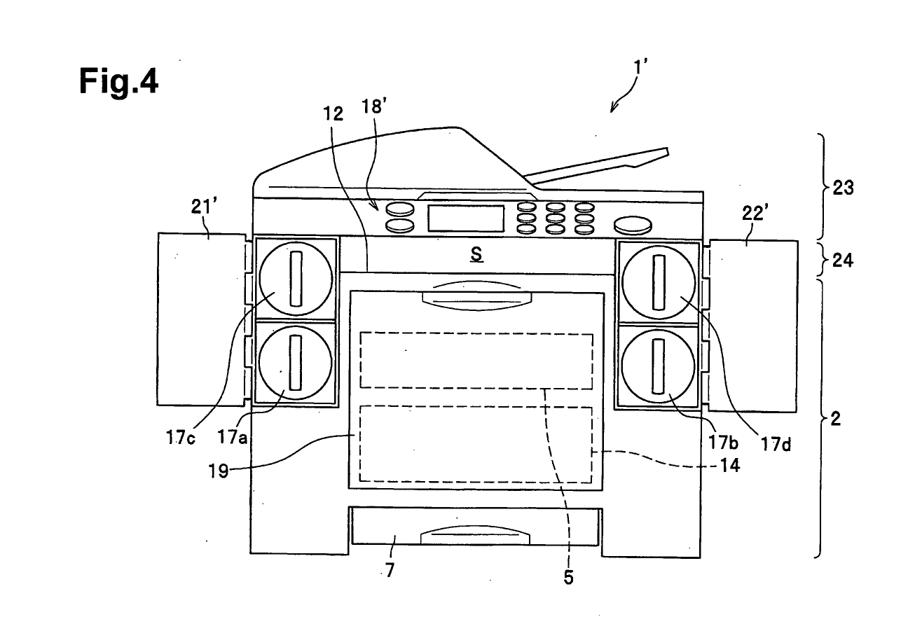

In the above embodiment, the color laser printer 1 is illustrated as an example of the image forming apparatus of the invention. The image forming apparatus according to aspects of the invention applies to a color multifunction apparatus 1′ shown in FIG. 4. The color multifunction apparatus 1′ may include a flatbed scanner 23 functioning as an image reading unit and a supporting member 24 on top of the body case 2. The flatbed scanner 23 may be disposed on top of the supporting member 24 and include an operation unit 18′ for manipulation by a user standing in front of the color multifunction apparatus 1′. The supporting member 24 may be disposed between the flatbed scanner 23 and the body case 2 and configured to support the flatbed scanner 23. In the color multifunction apparatus 1′, a sheet P having image thereon may be ejected through a space S enclosed between the body case 2, the flatbed scanner 23 and the supporting member 24, and located on the output tray 12.

In the color multifunction apparatus 1′, all or part of the toner cartridges 17a-17d may be positioned inside the supporting member 24. With this configuration, the inside space of the supporting member 24, which may be substantially hollow in a known color multifunction apparatus, can be efficiently used. In addition, as the process cartridges 13a-13d and the toner cartridges 17a-17d can be replaced from the front side of the body case 2 where the operation unit 18′ is manipulated, there is no need to make a design change relating to replacement of the toner cartridges 17a-17d even if the flatbed scanner 23 is provided. Thus, the above described body case 2 can be used for both the color laser printer 1 and the color multifunction apparatus 1′, the color laser printer 1 and the color multifunction apparatus 1′ can be manufactured in the same manufacturing line, and thus the cost of manufacturing can be reduced.

The above embodiment shows the process cartridges 13a-13d and the toner cartridges 17a-17d are configured to be capable of moving together in the same direction as the toner cartridges 17a-17d are attached or removed. However, the invention is not limited to the embodiment. For example, the process cartridges 13a-13d may be configured to be capable of moving together in the left-right direction. Alternatively, the process cartridges 13a-13d may be configured to be capable of being replaced independently.

While the features herein have been described in connection with various example structures and illustrative aspects, it will be understood by those skilled in the art that other variations and modifications of the structures and aspects described above may be made without departing from the scope of the invention. Other structures and aspects will be apparent to those skilled in the art from a consideration of the specification or practice of the features disclosed herein. It is intended that the specification and the described examples only are illustrative with the true scope of the inventions being defined by the following claims.

What is claimed is:

1. An image forming apparatus comprising:
a body case;
a plurality of image carriers arranged in a direction in the body case and each configured to carry an electrostatic latent image on a surface of a corresponding one of the image carriers;
an exposure unit configured to expose surfaces of the image carriers and form latent images on the surfaces of the image carriers; and
a plurality of developing agent storing members configured to store developing agents therein respectively, the developing agent storing members configured to be attached to and removed from the body case via a side of the body case on which an operation unit is operated, the developing agent storing members being configured to be attached to and removed from the body case in the direction of the arrangement of the image carriers.

2. The image forming apparatus according to claim 1, wherein the developing agent storing members are disposed on both sides of the exposure unit.

3. An image forming apparatus comprising:
a body case;
a plurality of image carriers arranged in a direction in the body case in a tandem arrangement, each configured to carry an electrostatic latent image on a surface of a corresponding one of the image carriers;
a plurality of developing agent storing members configured to store developing agents therein respectively, the developing agent storing members configured to be attached to and removed from the body case via a front side of the body case.

4. The image forming apparatus according to claim 3, wherein the developing agent storing members are arranged perpendicular to a shaft supporting each of the image carriers.

5. The image forming apparatus according to claim 3, further comprising:
a plurality of process cartridges, each corresponding to one of the image carriers,
wherein at least one process cartridge is disposed such that at least one of the developing agent storing members is located on a first side of the at least process cartridge and another of the developing agent storing members is located on a second side of the at least one process cartridge, where the first and second sides are opposite each other.

6. The image forming apparatus according to claim 3, wherein the plurality of image carriers are configured to be removed from the body as a group.

7. The image forming apparatus according to claim 3, wherein at least two of the developing agent storing members are disposed one above the other and horizontally displaced from each other.

8. The image forming apparatus according to claim 3, further comprising:
a scanner,
wherein the developing agent storing members are located below the scanner.

9. The image forming apparatus according to claim 3, further comprising:
a scanner,
wherein the developing agent storing members are located beside the scanner.

10. The image forming apparatus according to claim 3, wherein the plurality of developing agent storage members are configured to be removed from the body case independently of the removal of the plurality of image carriers from the body case.

11. The image forming apparatus according to claim 3, wherein the body case including a first door and a second door, and wherein at least one of developing agent storing members are configured to be attached to and removed from the body case via the first door of the body case, the plurality of image carriers configured to be removed from the body case via the second door.

12. The image forming apparatus according to claim 11, wherein the first door and the second door are on the front face of the body case.

13. The image forming apparatus according to claim 1, wherein the developing agent storing members are disposed to extend in the direction where the image carriers are arranged.

14. The image forming apparatus according to claim 1, wherein the exposure unit is disposed above the image carriers.

15. The image forming apparatus according to claim 1, wherein the image carriers are located in a first plane and at least one of the developer agent storing members is located in a second plane, wherein the second plane is higher than the first plane.

16. The image forming apparatus according to claim 14, further comprising:
an image reading part disposed above the body case; and
a supporting member disposed between the body case and the image reading part and being configured to support the image reading part,
wherein the developing agent storing members are disposed within the supporting member at least partially.

17. The image forming apparatus according to claim 13, wherein the image carriers are configured to be integrally attached to and removed from the body case in a same direction as the developing agent storing members are attached to and removed from the body case.
